(19) United States
(12) Patent Application Publication
(10) Pub. No.: US 2017/0115058 A1
(43) Pub. Date: Apr. 27, 2017

(54) SYSTEMS AND METHODS TO DRY WORKPIECES

(71) Applicant: Dürr Ecoclean GmbH, Filderstadt (DE)

(72) Inventors: Egon KÄSKE, Aachen (DE); Alexander GENZE, Simmerath (DE)

(21) Appl. No.: 15/398,516

(22) Filed: Jan. 4, 2017

Related U.S. Application Data
(63) Continuation-in-part of application No. PCT/EP2015/064473, filed on Jun. 25, 2015.

(30) Foreign Application Priority Data
Jul. 7, 2014 (DE) 102014213172

(51) Int. Cl. F26B 5/04; B08B 3/04

(52) U.S. Cl. CPC F26B 5/04; B08B 3/04; F01L 1/047

(57) ABSTRACT

Systems and methods to dry workpieces are disclosed. A disclosed example system for drying workpieces that have been applied with a liquid medium includes a workpiece receiving region to receive at least one workpiece to be dried, where the workpiece receiving region is implemented in a vacuum chamber that is closable in a relatively fluid-tight manner, and an evacuation device to evacuate the vacuum, where the evacuation device has a suction pump that is fluidly coupled on a suction side by a fluid line to the vacuum chamber. The workpiece receiving region is positioned in the vacuum chamber of a housing for enclosing a workpiece to be dried. The housing includes a housing wall with at least one passage opening for a gaseous fluid, where the housing has a suction connection, which is fluidly coupled by a suction device to a vacuum container that is ventable by a valve via the suction line to open and block the suction line to generate negative pressure at the suction connection.

### RELATED APPLICATION

This patent arises as a continuation-in-part of International Patent Application No. PCT/EP2015/064473, which was filed on Jun. 25, 2015, which claims priority to German Patent Application No. 10 2014 213 172, which was filed on Jul. 7, 2014. The foregoing International Patent Application and German Patent Application are hereby incorporated herein by reference in their entireties.

### FIELD OF THE DISCLOSURE

This disclosure relates generally to industrial production processes, and, more particularly, to systems and methods to dry workpieces.

### BACKGROUND

Systems and methods to dry workpieces are disclosed. In industrial production processes, workpieces are provided with liquid media in order to clean them of dirt particles or to treat the surface thereof with chemical substances. Dirt particles and liquid droplets can impair the functioning of industrially produced products such as, for example, injection nozzles for internal combustion engines. The cleanliness of workpieces in industrial production processes is consequently extremely important. Cleaning systems are used for cleaning workpieces in industrial production. In such systems, the workpieces are acted upon with liquid media, for example with water which is preferably provided with cleaning additives, or with process liquid which contains hydrocarbons. When, after the cleaning process, workpieces are processed further, installed or mounted, it frequently has to be ensured that the aforementioned liquid media have been substantially removed from the workpieces. Drying systems are operated in industrial production for this purpose.

### BRIEF DESCRIPTION OF THE DRAWINGS

FIG. 1 shows a first example system for drying workpieces with a vacuum chamber and a housing for enclosing a workpiece in the vacuum chamber.

FIG. 2 shows a partial view of a second example system with a vacuum chamber and a housing for enclosing a workpiece that is adapted to the outside contour of the workpiece.

FIG. 3 shows a partial view of a third example system with a vacuum chamber and a housing for enclosing a workpiece.

FIG. 4 shows a perspective partial view of the third example system of FIG. 3.

FIG. 5 shows a partial view of a fourth example system with a vacuum chamber and a housing for enclosing a workpiece that is adapted to the outside contour of the workpiece.

FIG. 6 shows a partial view of a fifth example system with a vacuum chamber and a housing for enclosing a workpiece that is adapted to the outside contour of the workpiece.

FIG. 7 shows a partial view of a sixth system with a vacuum chamber and a housing for enclosing a workpiece that is adapted to the outside contour of the workpiece.

FIG. 8 shows an example seventh system for drying workpieces with a housing for enclosing a workpiece.

FIG. 9 shows a partial view of the example seventh system along a direction generally indicated by an arrow IX of FIG. 8.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this patent, stating that any part is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

Systems and methods to dry workpieces are disclosed. The examples disclosed herein relate to a system for drying workpieces that have been acted upon with a liquid medium. The example systems include a workpiece receiving region to receive at least one workpiece to be dried. In addition, the examples disclosed herein also relate to a method for drying such workpieces.

As used herein, drying of workpieces is to be understood in the examples disclosed herein as the removal of liquid media, which is received on or clinging to a workpiece from the workpiece.

On one hand, drying ovens, in which the workpieces are provided with heat to evaporate liquid media clinging to the workpieces are used to dry workpieces in industrial production. In scenarios where workpieces have portions that take in liquid from liquid baths, a great deal of energy and time can be required to dry the workpieces using this drying method.

On the other hand, to dry workpieces in industrial production, the workpieces are moved about one or more workpiece axes by handling robots while the surfaces of the workpieces are simultaneously acted upon with blown air.

As seen in DE 42 37 335 A1, which is hereby incorporated by reference, a known system for drying is shown. In this known system, workpieces treated with a cleaning liquid can be exposed to negative pressure in a chamber that is closable in an air-tight manner. As a result of evacuating the chamber, remaining cleaning liquid clinging to a workpiece are evaporated. To remove cleaning liquid received in bores and blind holes during the cleaning process, this known system includes blow nozzles to generate air jets. As a result, workpieces are blown off by the air jets and, as a result, the cleaning liquid in the bores and blind holes of a workpiece is atomized.

A great deal of energy can be required to generate heat, provide negative pressure and to produce blowing air. Consequently, drying workpieces in industrial production can be the cause of significant costs. It is an object of the examples disclosed herein to reduce this energy expenditure necessary to dry workpieces that have been acted upon with liquid media.

For example, the aforementioned object can be achieved by a system with a suction device and a housing in which a workpiece that is positioned in the workpiece receiving region is able to be enclosed, where the housing includes a suction connection that is connected to the suction device by a suction line to generate negative pressure at the suction connection by the suction device (e.g., due to suctioning the suction line).

In this way, it can be achieved that liquid media adhered to a workpiece can be evaporated relatively quickly and, at the same time, be removed from the workpiece in the housing. A workpiece that is positioned in the workpiece receiving region and inside the housing, for example, in a preferred manner, can reduce the fluid volume situated in the housing (as a result of the effects of displacement).

Further, it is also an aspect of the examples disclosed herein for a negative pressure to be generated at the suction connection of the housing by the suction device caused by suctioning the suction line, thereby causing the negative pressure to produce a fluid flow from the interior of the housing into the suction line that acts upon a workpiece positioned in the workpiece receiving region.

Some of the examples disclosed herein utilize spaces, which are defined as flow ducts between a workpiece positioned in the housing, having a free cross sectional area that is reduced in relation to the surrounding area. The fluid flow in the housing flows to/in the workpiece receiving region via one or more constrictions in which the fluid flow is accelerated, slowed again and/or directionally reversed in portions on respective path(s) into and/or towards the suction line.

In some examples, the housing includes a housing wall having at least one passage opening for a gaseous fluid, through which the gaseous fluid is able to be drawn/sucked into the housing by the suction device based on the generated negative pressure at the suction connection.

When negative pressure is generated at the suction connection of the housing, a pressure gradient may be defined between the at least one passage opening and the suction connection such that a fluid flow through the housing is generated from the passage opening to the suction connection, for example.

According to the examples disclosed herein, the fluid flow extends along at least portions of the workpiece to be dried. In some examples, on account of the dynamic pressure that is dependent on the speed of the fluid flow, the static pressure on the surfaces of the workpiece that are to be dried is also modified at the same time and, at least in some portions, reduced, for example. It has been recognized that where static pressure is reduced in this manner based on the flow speed of the fluid flow, liquid droplets clinging to the surface of a workpiece can be removed in a particularly effective manner.

In a preferred manner, in some examples, constrictions are formed in portions between the housing and a workpiece. In particular, at these constrictions, the flow speed of the fluid flow may reach an increased and/or relative maximum such that the desired drying action is particularly strong. One aspect of the examples disclosed herein is for the fluid flow in the housing to be guided through cavities in a workpiece, in which the fluid flow is also accelerated in a localized manner.

In a preferred example, the suction device of the system includes a vacuum container that is ventable via the suction line and an evacuating device to evacuate the vacuum container. In this manner, it is possible to suction and/or draw very large quantities of gas out of the housing in a relatively short time such that a strong fluid flow is provided (e.g., provided temporarily). To open and block the aforementioned suction line in a preferably sudden manner, the system has, in some examples, a valve that is implemented as a flap valve.

It is also an aspect of the examples disclosed herein for the housing surrounding the workpiece receiving region to be positioned and/or disposed in a vacuum chamber that is closable in a relatively fluid-tight manner. The effect is that workpieces may be pre-dried in the housing as a result of being acted upon with a strong fluid flow and, after pre-drying, can then be subjected to vacuum drying as a result of evacuating the vacuum chamber. In such examples, when a workpiece is acted upon by a fluid flow in the vacuum chamber, a partial vacuum can be defined in the vacuum chamber as a result of applying negative pressure to the suction connection of the housing, for example. As a result, setting a relatively higher vacuum in the vacuum chamber for vacuum drying may be possible with reduced energy and time expenditure.

To evacuate the vacuum chamber, the evacuating device can include a suction pump that is coupled (e.g., fluidly coupled) and/or connected to the vacuum pump on the suction side via a fluid line. In some examples, it is advantageous when the system includes a line that communicates with the fluid line to the suction pump on the suction side for evacuating the vacuum container. In this manner, the evacuating device may be used both for evacuating the vacuum container as well as evacuating the vacuum chamber.

In some examples, the system may include a venting device for venting the vacuum chamber. The venting device, preferably, includes a valve that selectively opens or blocks a flow path for fluid that runs into the interior of the vacuum chamber, for example.

In some examples, the housing is generally shaped in a tunnel-shaped manner and positioned in the vacuum chamber. A linear movement device may be provided in the housing to displace workpieces in a linear manner through the housing from a first closable opening of the vacuum chamber to an additional opening of the vacuum chamber that is located opposite the first opening. Thus, it is possible to dry workpieces in the system with relatively short cycle times in this manner.

In some examples, the system can also include a housing that has a first housing part, which is displaceable relative to a second housing part of the housing for arranging workpieces in the workpiece receiving region. Arranging workpieces in the housing of the system can, thus, be simplified in this manner.

The examples disclosed herein also extend to a plant system for cleaning workpieces industrially. In some examples, the plant system includes a cleaning system in which workpieces are actable upon with a liquid medium, and has a system for drying workpieces which have been acted upon by a liquid medium with the aforementioned features.

Additionally or alternatively, the examples disclosed herein also extend to a method for drying workpieces that have been acted upon by a liquid medium, where a workpiece is positioned in a housing, and where the workpiece is acted upon with a gaseous fluid flow as a result of suctioning gaseous fluid out of the housing. It is, in particular, an aspect of the examples disclosed herein for the workpiece to be positioned in a vacuum chamber in the housing prior to vacuum drying, for example. It is advantageous, in such examples, when the housing is adapted at least in portions to the outside contour of the workpieces. The quantity of fluid to be conveyed in the system to set a vacuum in the vacuum chamber and to generate a fluid flow through the housing can be reduced in this manner, for example.

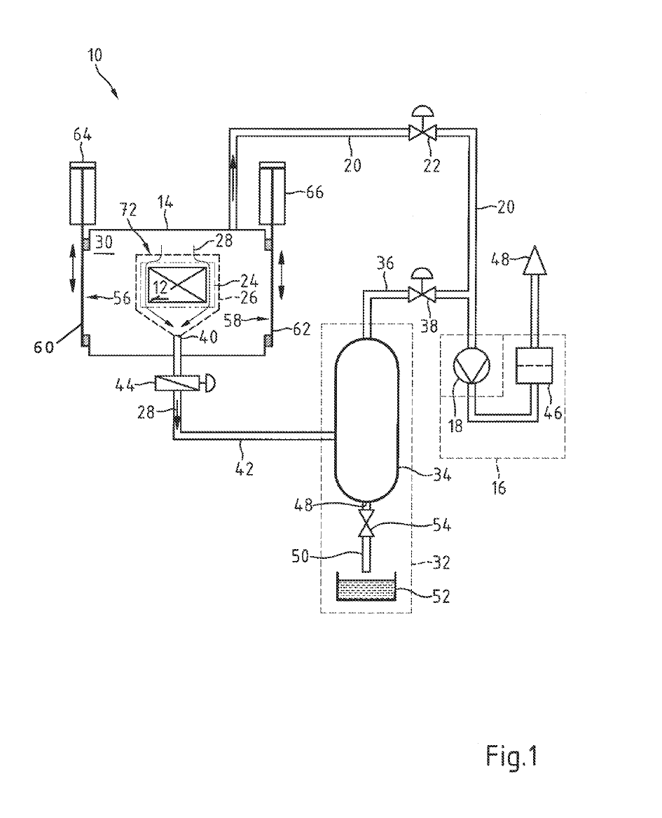

Turning to FIG. 1, the example system 10 for drying workpieces 12 includes a vacuum chamber 14 having an evacuatable interior 30. The example system 10 includes an evacuation device 16 to evacuate the vacuum chamber 14. The example evacuation device 16 also has an outlet 48 and a suction pump 18 that is fluidly coupled, in fluid communication with and/or connected to the vacuum chamber 14 via a pressure-resistant fluid line 20, in which a shut-off valve 22 is positioned. To dry the workpieces 12 in the system 10 of the illustrated example, the workpieces 12 are placed/positioned in a workpiece receiving region 24 within the vacuum chamber 14.

According to the illustrated example, a workpiece 12 is positioned in the workpiece receiving region 24 and enclosed in a housing 26 of the system 10. In this example, the housing 26 includes a housing wall with passage openings 72 for gaseous fluid. In this example, the passage openings 72 are passages that are positioned in the vacuum chamber 14 for gaseous fluid to flow from the evacuatable interior 30 of the vacuum chamber 14 into the interior of the housing 26.

The example system 10 includes a suction device 32, which has an evacuatable vacuum container 34 that is connected/coupled (e.g., fluidly coupled, fluidly connected, etc.) to the suction pump 18 by a line 36 for gaseous fluid that opens into the fluid line 20. In this example, the flow path for fluid between the vacuum container 34 and the suction pump 18 can be selectively opened and blocked via a shut-off valve 38 that is positioned in the line 36, for example. According to the illustrated example, a vacuum can be generated in the vacuum container 34 by the suction pump 18. In a preferred example, the residual gas pressure corresponding to the vacuum in the vacuum container is between approximately 20 millibar (mbar) and 100 mbar, for example.

The vacuum container 34 of the illustrated example has an outlet 48 to remove liquid accumulated therein by implementation of a fluid line 50 fluidly coupled to a receiving container 52 that can be selectively opened or blocked via a shut-off valve 54.

In this example, the housing 26 positioned in the vacuum chamber 14 has a suction connection 40 that is fluidly coupled/connected to the evacuatable vacuum container 34 of the suction device 32 by a suction line 42. A valve that is implemented as a flap valve 44 in this example is positioned in the suction line 42. According to the illustrated example, a flow path for fluid through the suction line 42 can be selectively opened or blocked by the flap valve 44. In particular, the flap valve 44 of the illustrated example is designed for short switching times and can, consequently, open the opening cross section of the suction line 42 in a relatively quick and/or sudden manner (e.g., within a time interval of the length, Δt≦1 second (s), preferably within a time interval of the length, Δt≦0.1 s).

To free and/or remove the gaseous fluid conveyed in the example system 10 via the suction pump 18 of liquid substances (e.g., cleaning liquids for cleaning workpieces 12), the fluid is caused to run/flow through a liquid separator 46 that is fluidly coupled to the pressure connection of the suction pump 18.

According to the illustrated example, to move the workpieces 12 in and out, the example vacuum chamber 14 includes two opposed openings 56, 58 that can be selectively opened or closed in a relatively fluid-tight manner using closing bodies 60, 62, which are implemented as bulkheads in this example. In this example, the system 110 includes actuating drives 64, 66 to move the closing bodies 60, 62.

According to the illustrated example, the system 10 is configured to dry workpieces 12 in two sequential/consecutive different modes of drying the workpieces, which have been acted upon with cleaning fluids on an industrial cleaning system, to clean the workpieces 12 of, for example, swarf and lubricants, etc. In some examples, the surfaces of the workpieces 12 are wetted or moistened with cleaning fluids. In such examples, the cleaning fluids to act upon the workpieces are also received in the recesses, bores and/or blind holes of the workpieces 12.

According to the illustrated example, the first drying mode of the system 10 enables workpieces 12 received therein to be pre-dried. Further, the second drying mode of the example system 10 enables workpieces 12, which have been pre-dried with the first mode of drying, to be efficiently vacuum dried.

After treatment in a cleaning system, the workpieces 12 of the illustrated example are positioned for pre-drying through the openings 56 or 58 in the workpiece receiving region 24 disposed in the housing 26. In this example, the openings having been opened by the closing bodies 60, 62. The closing bodies 60, 62 are then moved into their closed position by the actuating drives 64, 66. The openings 56, 58 of the vacuum chamber 41 to allow the workpieces 12 to move in and out are closed in a substantially fluid-tight manner. A vacuum is then produced in the vacuum container 34 of the suction device 32 by the evacuation device 16 via the line 36, with the shut-off valve 38 open in a corresponding manner. In some examples, the absolute residual pressure of the vacuum is preferably being between approximately 20 mbar and 100 mbar in some examples.

According to the illustrated example, negative pressure, which is preferably approximately 1 bar relative to atmospheric pressure, is then applied in a relatively sudden manner to the suction connection 40 due to opening the flap valve 44 in the suction line 42. As a result, a fluid flow 38, which enters through the openings 72 in the housing wall, is provided in the housing 26. In this example, the fluid flow flows/runs to the suction connection 40 and is guided through the suction line 42 into the vacuum container 34. According to the illustrated example, because the smallest cross section of the suction line 42 is greater than the sum of the entry surfaces of the openings 72 in the housing wall, where there is a sufficiently large pressure difference (ΔP:=PI−PV) between the pressure PI in the interior 30 of the vacuum chamber 14 and the pressure PV in the vacuum container 34 (e.g., ΔP≈½ PI≈0.5 bar), it is possible to achieve a speed of the fluid flow 28 (e.g., the speed at which the gaseous fluid flows out of the interior 30 of the vacuum chamber 14 into the housing 26 with the workpiece 12 positioned therein) being approximately and/or relatively close to the speed of sound, for example.

The workpiece 12 of the illustrated example is positioned in the housing 26 of the vacuum chamber 14 and can be, for example, an engine block. In such examples, it may be expedient when the volume of the vacuum container 34 is approximately 2 meters cubed (m³). The volume of the vacuum container 34 can, however, also be smaller, in principle, when the dimensions of the housing 26 are adapted to correspondingly smaller workpieces (e.g., to crankshafts or cam shafts).

According to the illustrated example, the fluid flow 28 provided to the interior of the housing 26 acts upon the surface of the workpiece 12, which is positioned in the workpiece receiving region 24, in a manner similar to applying blown air. In this example, the cleaning liquids, which are provided to the surface of the workpiece 12 and received in portions and/or interior spaces of the workpiece 12 that take in liquid, are ingested/taken by the fluid flow 28 and moved through the suction connection 40 of the housing 26 via the suction line 42 into the vacuum container 34 until a substantial equalized pressure and/or pressure equalization is defined between the vacuum container 34 and the interior of the housing 26, for example.

According to the illustrated example, when substantial pressure equalization prevails between the interior 30 of the vacuum chamber 114 and the vacuum container 34, vacuum drying is introduced in the system 10 by the second system operating mode. For example, the flap valve 44 is closed and the shut-off valve 22 is opened in the fluid line 20 to evacuate the vacuum chamber 14 as an entire unit by the evacuation device 16 to a residual pressure which, in some examples, may be less than the vapor pressure of the cleaning fluids received on and within (e.g., within portions of) the workpieces 12.

In some examples, when the pressure in the interior 30 of the vacuum chamber 14 falls below the vapor pressure of the cleaning fluids that adhere (e.g., cling) to a workpiece 12 positioned in the workpiece receiving region 24, the relevant cleaning fluids begin to boil. In such examples, the cleaning fluids may evaporate relatively quickly and are extracted through the fluid line 20 from the interior 30 of the vacuum chamber via the evacuation device 16 in order to be accumulated, if applicable, by the liquid separator 46, for example.

In the example of a mode of operation that is modified from the aforementioned mode of operation, it can be noted that pressure equalization between the vacuum container 34 and the vacuum chamber 14 in the system 10 can also be produced prior to the pre-drying of workpieces 12 when the closing bodies 60, 62 completely or partially open the openings 56, 58 of the vacuum chamber 14. In some examples, the closing bodies 60, 62 are not moved into the closed position until the fluid flow through the housing 26, which is produced by the pressure equalization with the vacuum container 34, has come to a substantial standstill (e.g., a full standstill).

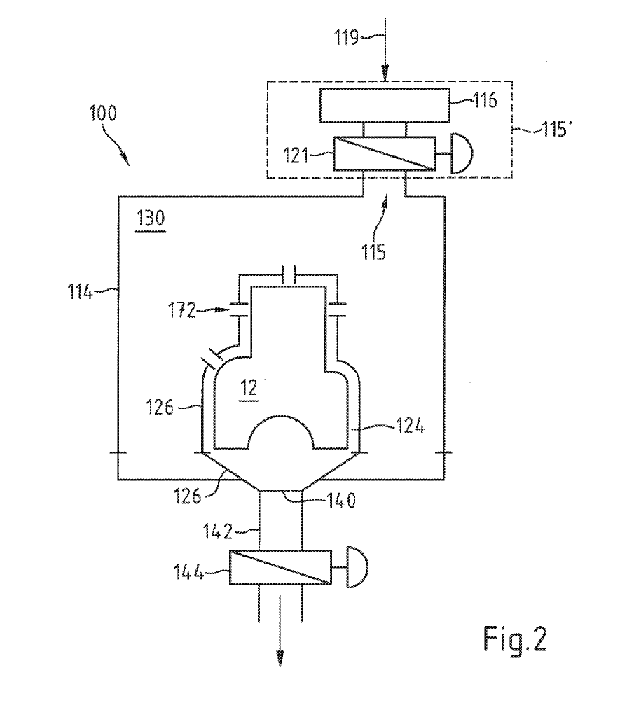

FIG. 2 shows a partial view of a second example system 100 having a vacuum chamber 114 and a housing 126 to enclose a workpiece 12. The housing 126 of the illustrated example is generally shaped and/or adapted to the outside contour of the workpiece in the system 100. Insofar as the assemblies of the second system 100 correspond to the assemblies of the above-described system 10, they are identified with numbers incremented by the number 100 as reference symbols. The example vacuum chamber 114 includes a venting device 115′ having a supply air opening 115. In this example, the supply air opening 115 can be selectively opened or blocked via a flap valve 121. In some examples, the supply air opening 115 has a corresponding sound absorber 116, through which ambient air is able to flow into the interior of the vacuum chamber 114 along the direction of the arrow 119 when a fluid flow, which acts upon a workpiece 12 positioned in a workpiece receiving region 124 in the housing 126, is brought about through the housing 126 due to producing pressure equalization with a vacuum container.

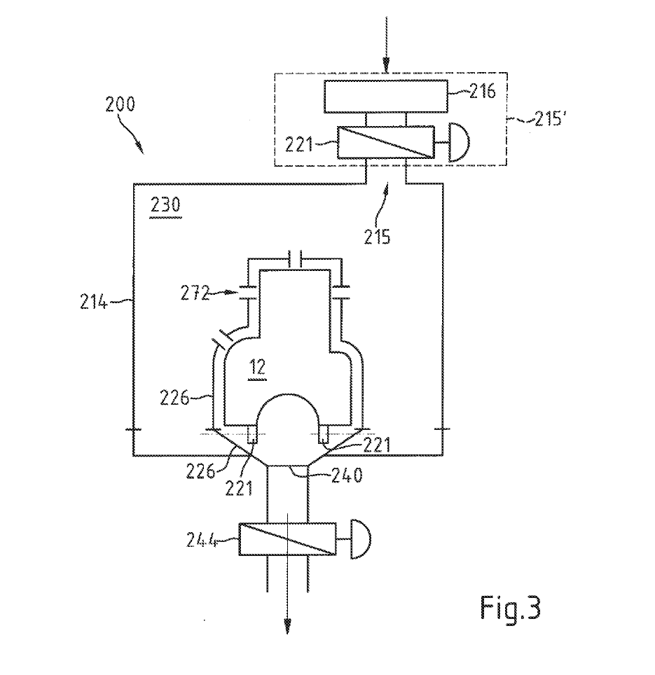

FIG. 3 shows a partial view of a third example system 200 with a vacuum chamber 214 and a housing 226 to enclose a workpiece 12.

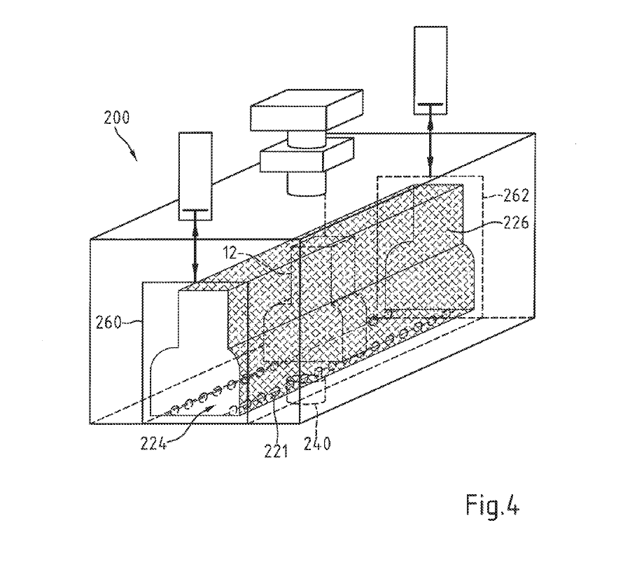

FIG. 4 is a perspective partial view of the third example system 200 of FIG. 3. According to the illustrated example, the housing 226 is generally shaped and/or adapted to the outside contour of the workpiece in the system 200. Insofar as the assemblies of the third system 200 correspond to the assemblies of the above-described system 10, they are identified with numbers incremented by the number 200 as reference symbols. In the example system 200, the housing 226 is positioned in the vacuum chamber 214 and sealed by the closing bodies 260, 262 of the vacuum chamber 214. According to the illustrated example, the interior of the housing 226 having the workpiece receiving region 224 provided therein is developed and/or generally shaped in a tunnel-like manner. In this example, the vacuum chamber 214 has a linear movement device that is implemented as a roller conveyor 221′ on which the workpieces 12 can be moved through the workpiece receiving region 224.

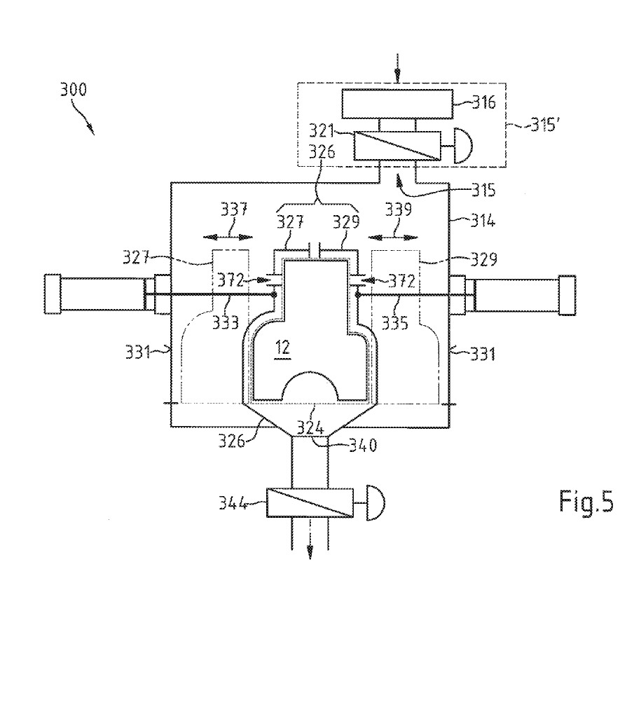

FIG. 5 shows a partial view of a fourth example system 300 having a vacuum chamber 314 and a housing 326 for enclosing a workpiece 12 in a workpiece receiving region 324. Insofar as the assemblies of the fourth system 300 correspond to the assemblies of the above-described system 10, they are identified with numbers incremented by the number 300 as reference symbols. According to the illustrated example, the housing 326 of the system 300 is implemented in two parts. In particular, the example housing 326 includes a first housing part 327 and an additional housing part 329, both of which are displaceable relative to one another via movement members 333, 335, which extend through the wall 331 of the vacuum chamber 314, along a direction generally indicated by indicated by double arrows 337, 339 in a successive order as well as in a selective manner to release and/or to surround a workpiece positioned in the workpiece receiving region 324 of the vacuum chamber 314, for example.

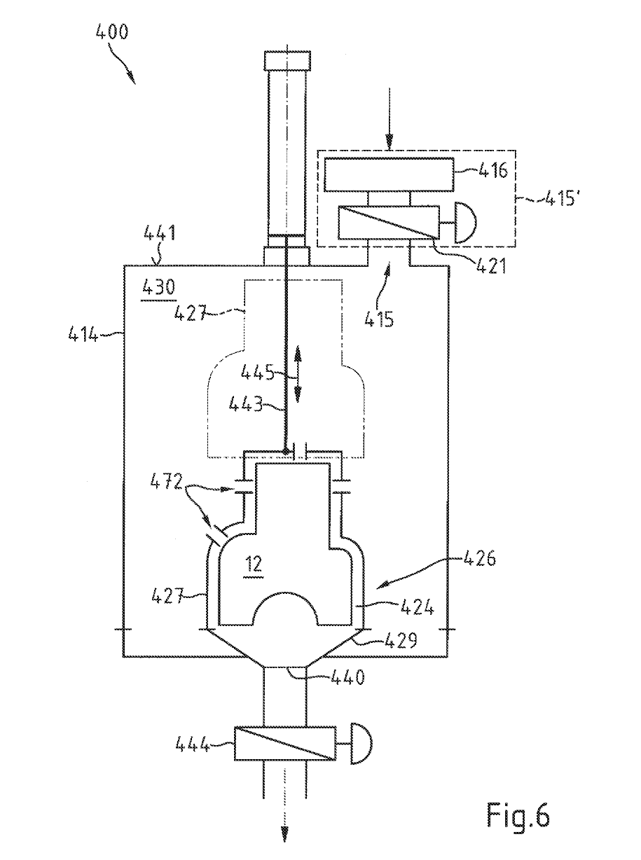

FIG. 6 shows a partial view of a fifth example system 400 having a vacuum chamber 414 and a housing 426 to enclose a workpiece 12. Insofar as the assemblies of the fifth system 400 correspond to the assemblies of the above-described system 10, they are identified with numbers incremented by the number 400 as reference symbols. According to the illustrated example, the housing 426 of the system 400 includes a portion that is implemented in a general bell-like shape as a first housing part 427, which can be raised and lowered relative to the second housing part 429 in the interior 430 of the vacuum chamber 414 along a direction generally indicated by a double arrow 445 via a movement member 443, which extends though the cover 441 of the vacuum chamber 414 to release or to surround, in a selective manner, a workpiece 12 that is positioned in the workpiece receiving region 424 of the vacuum chamber 414, for example.

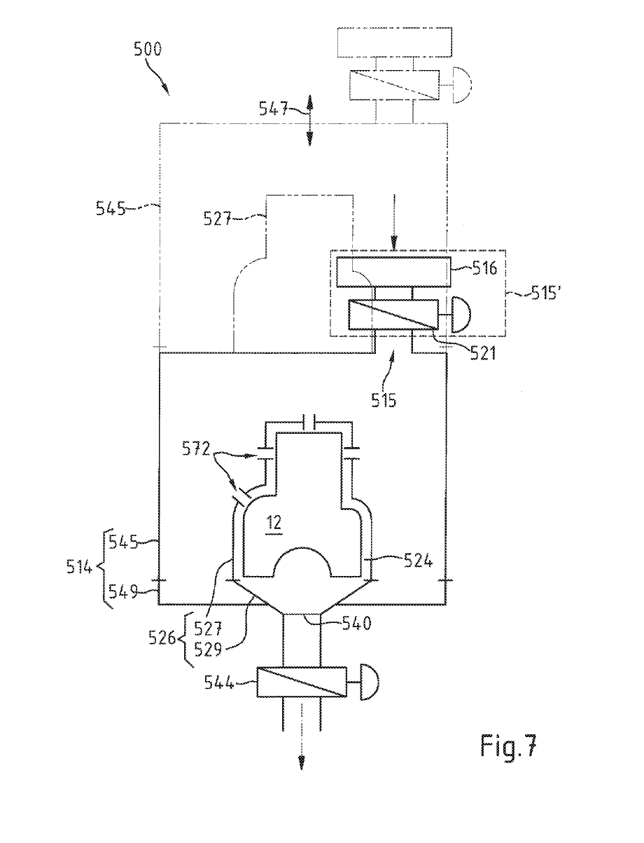

FIG. 7 shows a partial view of a sixth example system 500 having a vacuum chamber 514 and a housing 526 to enclose a workpiece 12 in a workpiece receiving region 524. Insofar as the assemblies of the sixth system 500 correspond to the assemblies of the above-described system 10, they are identified with numbers incremented by the number 500 as reference symbols.

The example vacuum chamber 514 of the system 500 is implemented in two parts. In particular, the vacuum chamber 514 of the illustrated example has a chamber part 545, which can be raised and lowered in relation to a chamber part 549 along a direction generally indicated by a double arrow 547 via an appropriate movement manner. According to the illustrated example, the housing 526 is also implemented with multiple parts. The example housing 526 has a portion 527 that is displaceable relative to a portion 529. In this example, the portion 527 of the housing 526 is positioned in a stationary manner relative to the chamber part 545 and the portion 529 of the housing 526 is stationary relative to the chamber part 549.

In this example, the chamber part 545 can be moved by the movement member between a closed and an open position. For example, in the open position, the workpiece receiving region 524 is opened for supply and removal of workpieces 12. In the closed position, a workpiece 12 positioned in the workpiece receiving region 524 is enclosed by the housing 526, for example.

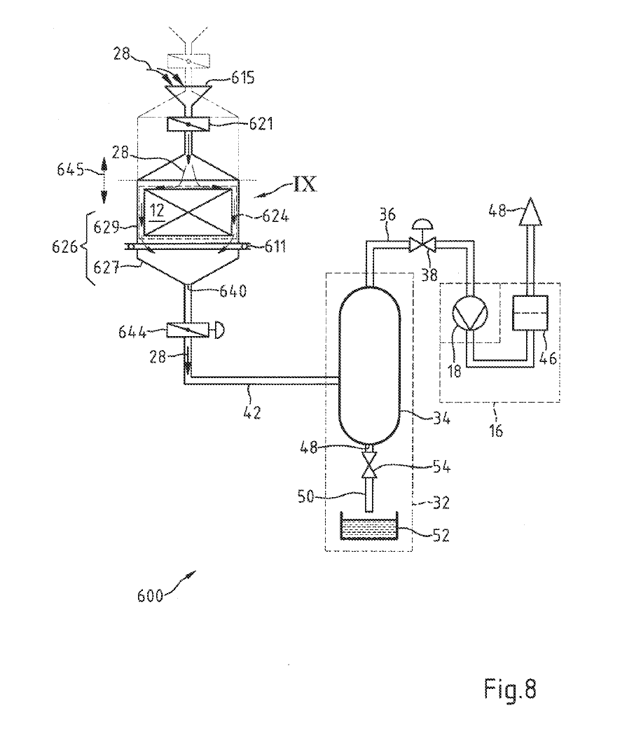

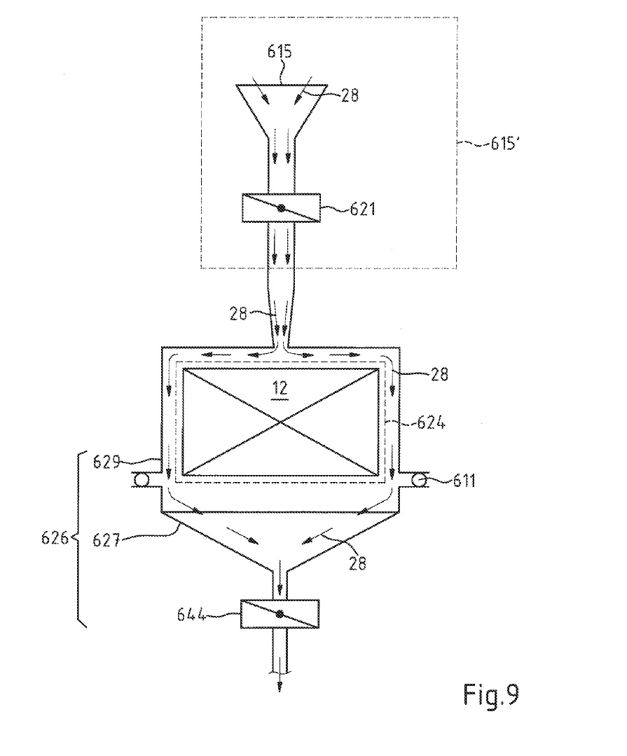

FIG. 8 shows a seventh example system 600 for drying workpieces 12. FIG. 9 is a partial view of the system 600 of FIG. 8 along a direction generally indicated by an arrow IX of FIG. 8. According to the illustrated example, the system 600 for drying workpieces 12 includes a workpiece receiving region 624 and a housing 626 having a first housing part 627 and a second housing part 629, which is displaceable relative to the first housing part 627 between an open and a closed position via a drive, for example. In this example, the housing 626 is adapted and/or shaped to the general form of the lateral portions of the workpiece 12 such that dimensions of the space that is defined by the housing 626 are only slightly larger than a workpiece 12 (e.g., the space surrounding the workpiece 612 is slightly larger than the workpiece 12) positioned in the workpiece receiving region 624. The workpiece 12 positioned in the workpiece receiving region 624 of the system 600 may be, for example, an engine block.

The first housing part 627 is implemented in a generally funnel-like shape and includes a suction flap that is implemented as a flap valve 644. The second housing part 629 is generally hood-shaped and includes a funnel-shaped opening 615 with a flap valve 621. To move the workpieces 12 in and out of the workpiece receiving region 624, the second housing part 629 of the illustrated example is moved into the open position relative to the first housing part 627. In the closed position, the second housing part 629 abuts against and/or contacts a seal 611 that is positioned between the first housing part 627 and the second housing part 629. In this example, the first housing part 627 along with the second housing part 629 defines a vacuum chamber that can be vented by the flap valve 621 and evacuated by the suction flap that is implemented as a flap valve 644, for example.

According to the illustrated example, the system 600 includes an evacuation device 16 to evacuate the vacuum chamber that is defined when placing the second housing part 629 against the first housing part 627. To dry workpieces 12 in the system 600, the workpieces are positioned in a workpiece receiving region 624 of the vacuum chamber that is defined by the first housing part 627 and the second housing part 629 of the housing 626.

The system 600 of the illustrated example includes a suction device 32. The example suction device 32 includes an evacuatable vacuum container 34 that is fluidly coupled to the suction pump 18 of an evacuation device 16 via a line 36 that is used for gaseous fluid, for example. In this example, the evacuation device 16 has an outlet 48 and includes a suction pump 18. By way of a shut-off valve 38 that is positioned in the line 36, the flow path for fluid between the vacuum container 34 and the suction pump 18 can be selectively opened and blocked. Accordingly, it is possible to generate a vacuum in the vacuum container 34 by the suction pump 18. In a preferred manner, in some examples, the residual gas pressure for the vacuum in the vacuum container is between approximately 20 mbar and 100 mbar, for example.

The vacuum container 34 of the illustrated example has an outlet 48 to remove liquid that has accumulated therein via a fluid line 50 into a receiving container 52, which can be selectively opened or blocked by a shut-off valve 54, for example.

In this example, a flow path for fluid with a fluid flow 28 through the suction line 42 can be selectively opened and blocked by means of the flap valve 644. The flap valve 644, in this case, is designed for short switching times and can, consequently, open the opening cross section of the suction line 42 in a sudden manner (e.g., within a time interval of the length Δt≦1 s, preferably within a time interval of the length Δt≦0.1 s).

To free the gaseous fluid conveyed in the system 600 of liquid substances, such as, for instance, cleaning liquids for cleaning workpieces 12 by the suction pump 18, the fluid is run and/or flows through a liquid separator 46, which is fluidly coupled to the pressure connection of the suction pump 18.

The system 600 is also implemented for drying workpieces 12 that have been acted upon with cleaning fluids in an industrial cleaning system to clean them of, for example, swarf and lubricants, etc. In this example, the surfaces of the workpieces 12 are wet/wetted (e.g., moistened) and/or applied with cleaning fluids. In this example, the cleaning fluids acting upon the workpieces are also received in the recesses, bores and blind holes of the workpieces 12.

After treatment in a cleaning system, the workpieces 12 of the illustrated example are positioned in the workpiece receiving region 624 to dry. In some examples, the second housing part 629 and the first housing part 627 of the housing 626 are then moved toward one another into the closed position.

According to the illustrated example, a vacuum is then defined in the vacuum container 34 of the suction device 32 by the evacuation device 16 via the line 36, and with the shut-off valve 38 open in a corresponding manner, the absolute residual pressure of the vacuum, preferably being between approximately 20 mbar and 100 mbar, for example.

Negative pressure, which is preferably approximately 1 bar relative to atmospheric pressure in some examples, is then applied in a relatively sudden manner to a suction connection 40 of the first housing part 627 by opening the flap valve 644 in the suction line 42. As a result, a fluid flow 28, which enters through the opening 615 and the flap valve 621 into the housing 626, is provided in the housing 26. In particular, the fluid flow of the illustrated example flows to the suction connection 640 and is guided through the suction line 42 into the vacuum container 34.

According to the illustrated example, the housing 626 includes walls, which with a workpiece 12 positioned in the workpiece receiving region 624, narrow the cross sectional flow for the fluid flow 28 entering into the housing 626. The effect is that the flow speed of the fluid flow 28 is increased at the surface of the workpiece 12 and can be strong enough to detach liquid residue and/or contaminants from the surface of the workpiece 12, for example.

In this example, the fluid flow 28 provided in the interior of the housing 626 acts upon the surface of the workpiece 12 positioned in the workpiece receiving region 624 in a similar manner to blown air. The cleaning liquids, which are received on the surface of the workpiece 12 and, in portions, taken in liquid or in interiors of the workpiece, are received by the fluid flow 28 and moved through the suction connection 640 via the suction line 42 into the vacuum container 34 until substantial pressure equalization is defined between the vacuum container 34 and the interior of the housing 26.

In summary, the following preferred features of the examples disclosed herein are to be noted. The examples disclosed herein relate to a system 10, 100, 200, 300, 400, 500, 600 for drying workpieces 12, 112, 212, 312, 412, 512, 612, which have been acted upon with a liquid medium. The system 10, 100, 200, 300, 400, 500, 600 includes a workpiece receiving region 24, 124, 224, 324, 424, 524, 624 to receive at least one workpiece 12 to be dried. The system 10, 100, 200, 300, 400, 500, 600 includes a suction device 32 and a housing 26, 126, 226, 326, 426, 526, 626, in which a workpiece 12 is positioned in the workpiece receiving region 24, 124, 224, 324, 424, 524, 624 is to be enclosed. The example housing 26, 126, 226, 326, 426, 526, 626 includes a suction connection 40, 140, 240, 340, 440, 540, 640 that is fluidly coupled to the suction device 32 via a suction line 42.

An example system 10, 100, 200, 300, 400, 500, 600 for drying workpieces 12 which have been acted upon with a liquid medium, includes a workpiece receiving region 24, 124, 224, 324, 424, 524, 624 for receiving at least one workpiece 12 to be dried, said workpiece receiving region being realized in a vacuum chamber 14, 114, 214, 314, 414, 514 which is closable in a fluid-tight manner. The example system also includes an evacuation device 16 for evacuating the vacuum chamber 14, 114, 214, 314, 414, 514 which includes a suction pump 18 which is connected on the suction side by means of a fluid line 20 to the vacuum chamber 14, characterized in that the workpiece receiving region 24, 124, 224, 324, 424, 524, 624 is situated in the vacuum chamber 14, 114, 214, 314, 414, 514 in a housing 26, 126, 226, 326, 426, 526, 626 for enclosing a workpiece 12 to be dried and said housing comprises a housing wall with at least one passage opening 72, 172, 272, 372, 472, 572 for a gaseous fluid, wherein the housing 26, 126, 226, 326, 426, 526, 626 has a suction connection 40, 140, 240, 340, 440, 540, 640, which is connected by way of a suction device 32 to a vacuum container 34, which is ventable by means of a valve 44, 144, 244, 344, 444, 544, 644 via the suction line 42 for opening and blocking the suction line 42, for generating negative pressure at the suction connection 40, 140, 240, 340, 440, 540, 640.

In some examples, the negative pressure is generatable at the suction connection 40 of the housing 26 as a result of suctioning the suction line 42 by way of the suction device 32, said negative pressure producing a fluid flow 28 into the suction line 42 which acts upon a workpiece 12 arranged in the workpiece receiving region 24, 124, 224, 324, 424, 524, 624. In some examples, the gaseous fluid is able to be sucked into the housing 26, 126, 226, 326, 426, 526 through the at least one passage opening 72, 172, 272, 372, 474, 572 by way of the suction device 32 as a result of generating negative pressure at the suction connection 40, 140, 240, 340, 440, 540, 640.

In some examples, the evacuation device 16 serves for evacuating the vacuum container 34. In some examples, the valve is realized as a flap valve 44, 144, 244, 344, 444, 544, 644. In some examples, for evacuating the vacuum chamber 14, 114, 214, 314, 414, 514, the evacuating device 16 includes a suction pump 18 which is connected on the suction side to the vacuum chamber 14 by means of a fluid line 20. Some examples include a line 36 which communicates on the suction side with the fluid line 20 to the suction pump 18 for evacuating the vacuum container 34. Some examples include a venting device 115′, 215′, 315′, 415′, 515′, 615′ for venting the vacuum chamber 114, 214, 314, 414, 514. In some examples, the venting device 115′, 215′, 315′, 415′, 515′, 615′ includes a valve 121, 221, 321, 421, 521, 621 which selectively opens or blocks a flow path for fluid which runs into the interior of the vacuum chamber 114.

In some examples, the housing 226 is developed in a tunnel-shaped manner in the vacuum chamber 214 and a linear movement device 224 is provided for displacing workpieces 212 in a linear manner through the housing 226 from a first closable opening of the vacuum chamber 214 to a further opening of the vacuum chamber 214 which is located opposite the first opening. In some examples, the housing 326, 426, 526 comprises a first housing part 327, 427, 527, 627 which is displaceable in relation to a second housing part (329, 429, 529, 629 of the housing 326, 426, 526 for arranging workpieces 312 in the workpiece receiving region 324, 424, 524, 624.

In some examples, the vacuum chamber 514 comprises a first chamber part 549 with a portion 529 of the housing 526 secured therein and has a further chamber part 545, which is displaceable relative to the first chamber part 549 between a closed and an open position, with a further portion 527 of the housing 526 secured therein, in order to release the workpiece receiving region 524 for the supply and removal of workpieces 512 in the open position and to enclose a workpiece 512 that is arranged in the workpiece receiving region 524 in the housing 526 in the closed position.

An example plant system for cleaning workpieces 12 industrially having a cleaning system in which workpieces 12 are actable upon with a liquid medium and having a system 10 that is realized as described above for drying workpieces 12 that have been acted upon with a liquid medium.

An example method for drying a workpiece 12 which has been acted upon with a liquid medium includes arranging the workpiece 12 in a vacuum chamber 14 in a housing 26, and acting upon the workpiece with a gaseous fluid flow 28 by means of suctioning gaseous fluid out of the housing 26 as a result of connecting the vacuum chamber 14 to an evacuated vacuum container 34.

In some examples, the housing 226, 626 is adapted at least in portions to the outside contour of the workpieces 112.

An example system for drying workpieces that have been applied with a liquid medium includes a workpiece receiving region to receive at least one workpiece to be dried, where the workpiece receiving region is implemented in a vacuum chamber that is closable in a relatively fluid-tight manner, and an evacuation device to evacuate the vacuum, where the evacuation device has a suction pump that is fluidly coupled on a suction side by a fluid line to the vacuum chamber. The workpiece receiving region is positioned in the vacuum chamber of a housing for enclosing a workpiece to be dried. The housing includes a housing wall with at least one passage opening for a gaseous fluid, where the housing has a suction connection, which is fluidly coupled by a suction device to a vacuum container that is ventable by a valve via the suction line to open and block the suction line to generate negative pressure at the suction connection.

In some examples, the negative pressure is generated at the suction connection of the housing from suctioning the suction line via the suction device, where the negative pressure is to produce a fluid flow into the suction line that acts upon a workpiece positioned in the workpiece receiving region. In some examples, the gaseous fluid is to be drawn into the housing through the at least one passage opening via the suction device generating the negative pressure at the suction connection. In some examples, the evacuation device is to evacuate the vacuum container. In some examples, the valve is a flap valve. In some examples, to evacuate the vacuum chamber, the evacuating device includes a suction pump that is fluidly coupled on the suction side to the vacuum chamber by a fluid line.

In some examples, the system further includes a venting device to vent the vacuum chamber. In some examples, the venting device includes a valve that selectively opens or blocks a flow path for fluid that flows into the interior of the vacuum chamber.

In some examples, the housing is shaped in a generally tunnel-shaped manner in the vacuum chamber and further includes a linear movement device to displace workpieces in a linear manner through the housing from a first closable opening of the vacuum chamber to an additional opening of the vacuum chamber that is located opposite the first opening. In some examples, the housing includes a first housing part that is displaceable relative to a second housing part of the housing for positioning workpieces in the workpiece receiving region.

In some examples, the vacuum chamber includes a first chamber part with a portion of the housing secured therein and has an additional chamber part that is displaceable relative to the first chamber part between a closed and an open position, with a further portion of the housing secured therein to release the workpiece receiving region for the supply and removal of workpieces in the open position and to enclose a workpiece that is positioned in the workpiece receiving region in the housing in the closed position.

An example plant system for industrially cleaning workpieces having a cleaning system in which workpieces are applied with a liquid medium and has a system including any of the aforementioned features for drying workpieces that have been applied with a liquid medium.

An example method for drying a workpiece that has been applied with a liquid medium includes positioning the workpiece in a vacuum chamber in a housing, and acting upon the workpiece with a gaseous fluid flow by means of suctioning gaseous fluid out of the housing as a result of coupling the vacuum chamber to an evacuated vacuum container.

In some examples, the housing is adapted, at least in portions, to the outside contour of the workpieces.

This patent arises as a continuation-in-part of International Patent Application No. PCT/EP2015/064473, which was filed on Jun. 25, 2015, which claims priority to German Patent Application No. 10 2014 213 172, which was filed on Jul. 7, 2014. The foregoing International Patent Application and German Patent Application are hereby incorporated herein by reference in their entireties.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A system for drying workpieces that have been applied with a liquid medium, comprising:
a workpiece receiving region for receiving at least one workpiece to be dried, the workpiece receiving region being implemented in a vacuum chamber that is closable in a relatively fluid-tight manner; and
an evacuation device to evacuate the vacuum chamber, the evacuation device having a suction pump that is fluidly coupled on a suction side by a fluid line to the vacuum chamber, wherein the workpiece receiving region is positioned in the vacuum chamber of a housing for enclosing a workpiece to be dried, the housing including a housing wall with at least one passage opening for a gaseous fluid, wherein the housing has a suction connection, which is fluidly coupled by a suction device to a vacuum container that is ventable by a valve via the suction line to open and block the suction line to generate negative pressure at the suction connection.

2. The system as defined in claim 1, wherein the negative pressure is generated at the suction connection of the housing from suctioning the suction line via the suction device, the negative pressure to produce a fluid flow into the suction line that acts upon a workpiece positioned in the workpiece receiving region.

3. The system as defined in claim 1, wherein the gaseous fluid is to be drawn into the housing through the at least one passage opening via the suction device generating the negative pressure at the suction connection.

4. The system as defined in claim 1, wherein the evacuation device is to evacuate the vacuum container.

5. The system as defined in claim 1, wherein the valve is a flap valve.

6. The system as defined in claim 1, wherein to evacuate the vacuum chamber, the evacuating device includes a suction pump that is fluidly coupled on the suction side to the vacuum chamber by a fluid line.

7. The system as defined in claim 6, further including a line that is fluidly coupled on the suction side with the fluid line to the suction pump for evacuating the vacuum container.

8. The system as defined in claim 1, further including a venting device to vent the vacuum chamber.

9. The system as defined in claim 8, wherein the venting device includes a valve that selectively opens or blocks a flow path for fluid that flows into the interior of the vacuum chamber.

10. The system as defined in claim 1, wherein the housing is shaped in a generally tunnel-shaped manner in the vacuum chamber and further including a linear movement device to displace workpieces in a linear manner through the housing from a first closable opening of the vacuum chamber to an additional opening of the vacuum chamber that is located opposite the first opening.

11. The system as defined in claim 1, wherein the housing includes a first housing part that is displaceable relative to a second housing part of the housing for positioning workpieces in the workpiece receiving region.

12. The system as defined in claim 1, wherein the vacuum chamber includes a first chamber part with a portion of the housing secured therein and has an additional chamber part that is displaceable relative to the first chamber part between a closed and an open position, with a further portion of the housing secured therein to release the workpiece receiving region for the supply and removal of workpieces in the open position and to enclose a workpiece that is positioned in the workpiece receiving region in the housing in the closed position.

13. A plant system for industrially cleaning workpieces having a cleaning system in which workpieces are applied with a liquid medium and having a system that is defined in claim 1 for drying workpieces that have been applied with a liquid medium.

14. A method for drying a workpiece which has been acted upon with a liquid medium, comprising:
positioning the workpiece in a vacuum chamber in a housing; and
acting upon the workpiece with a gaseous fluid flow by means of suctioning gaseous fluid out of the housing as a result of coupling the vacuum chamber to an evacuated vacuum container.

15. The method as defined in claim 14, wherein the housing is adapted, at least in portions, to the outside contour of the workpieces.
